(19) United States
(12) Patent Application Publication
(10) Pub. No.: US 2026/0071091 A1
(43) Pub. Date: Mar. 12, 2026

(54) SELF-HEALING TRANSPARENT COATING COMPOSITION USING SUNLIGHT AND APPLICATION THEREOF

(71) Applicant: KOREA RESEARCH INSTITUTE OF CHEMICAL TECHNOLOGY, Daejeon (KR)

(72) Inventors: Jin Chul KIM, Daejeon (KR); jI Eun JEONG, Daejeon (KR); Young II PARK, Daejeon (KR); Sang Ho LEE, Daejeon (KR); Da Hae SON, Daejeon (KR)

(73) Assignee: KOREA RESEARCH INSTITUTE OF CHEMICAL TECHNOLOGY, Daejeon (KR)

(21) Appl. No.: 18/858,032

(22) PCT Filed: Apr. 19, 2023
(86) PCT No.: PCT/KR2023/005261

§ 371 Date: Oct. 18, 2024

(30) Foreign Application Priority Data
Apr. 21, 2022 (KR) 10-2022-0049267

(51) Int. Cl. C09D 133/14; C09D 5/32; C09D 7/41; C09D 7/63

(52) U.S. Cl. CPC C09D 133/14; C09D 5/32; C09D 7/41; C09D 7/63

(57) ABSTRACT

Provided are a clearcoat having a self-healing thermoreversible network by topically generating heat in a scratched site using NIR laser, using a reversible bond occurring by heat by sunlight or heat at high temperature occurring in the photothermal dye by ultraviolet rays, by including: a multi-functional crosslinking agent including a hindered urea structure and an alkylene oxide repeating unit and a photothermal dye compound generating heat by mainly absorbing light in the NIR region, as a coating composition capable of self-healing scratches occurring on the surface, and a method for preparing the same.

### TECHNICAL FIELD

The present invention relates to a transparent coating preparation capable of self-healing under sunlight using an organic photothermal molecule.

### BACKGROUND ART

Physical damage such as scratches on a coating on transport equipment, electronic products, and the like corrodes a metal substrate protected by coating to cause functional impairment of the substrate and also significantly deteriorate product appearance quality.

A method for solving the problem is using a coating composition having high physical properties for completely excluding the physical damage. However, the method incurs a lot of costs, and it is almost impossible to develop a coating composition having the physical properties to completely exclude the physical damage. For this reason, various self-healing coating systems for recovering the physical damage by external stimuli such as heat and pressure have been studied in industry and academia for a while, and among them, a resin including a thermoreversible hindered urea bond has a very high value with self-healing technology appropriate for industries such as transport equipment, electronics, and construction which require high mechanical properties, by having a dynamic crosslinking system.

A conventional technology related to a method for preparing a self-healing polyurethane includes Korean Patent Laid-Open Publication No. 2018-0078834 related to a method for preparing a self-healing polymer characterized by including: reacting diisocyanate with tertiary butal diamine to form a polyurea prepolymer and reacting the polyurethane prepolymer and the polyurea prepolymer with a crosslinking agent to form a polymer, and Korean Patent Laid-Open Publication No. 2018-0026417 related to a self-healing polyurethane obtained by curing a mixture including a polyurethane prepolymer and an anhydrous sugar alcohol.

In general, since a self-healing function of a reversible self-healing coating system is determined by flowability of a polymer, it is very difficult to implement high mechanical properties and self-healing function simultaneously. In addition, most reversible self-healing coating systems which have been reported to date are prepared by preparing a multi-functional curing agent having a reversible self-healing nature and chemically reacting the curing agent with a resin including a reactive functional group, and the method has a disadvantage of causing self-healing performance degradation by a rapid increase of polymer system curing due to an increase in a self-healing curing agent composition.

Recently, a study of a self-healing phenomenon by light has been conducted using inorganic photothermal molecules having an excellent photothermal effect such as carbon nanotubes, graphene, and metal nanoparticles, but since the materials absorb light in the visible light region and show a dark color, they are inappropriate for being introduced as a coating material.

Therefore, the introduction of organic photothermal molecules having less absorption of light in the visible light region and high photothermal efficiency is needed for a self-healing coating system having high transmittance.

### DISCLOSURE

### Technical Problem

An object of the present invention is to provide a transparent coating composition which may self-heal scratches occurring on the surface and has transparent and high mechanical properties, and a clearcoat.

### Technical Solution

In one general aspect, a topical self-healing transparent coating composition capable of forming a polymer network includes: a polyacryl-based resin including a hydroxyl group at the end of a side chain;
a multi-functional alcohol including two or more hindered urea structures in the molecule and a hydroxyl group at both ends of the molecule; a crosslinking agent including hydroxyl group or isocyanate group; and
a photothermal dye.

According to an exemplary embodiment of the present invention, the hydroxyl group of the multi-functional alcohol may be included at 10 to 40 mol % of the total hydroxyl groups of the coating composition.

According to an exemplary embodiment of the present invention, the isocyanate group of the crosslinking agent may be included at a mole ratio of 0.8 to 1.2 to the total hydroxyl groups of the coating composition.

According to an exemplary embodiment of the present invention, the hindered urea structure may include a structure of the following Chemical Formula 1 or 2:

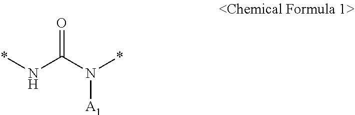

wherein A₁ is a C4 to C7 branched chain alkyl group,

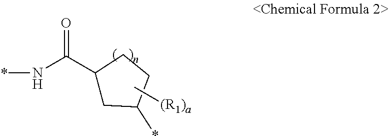

wherein a is 1 to 4, n is 1 to 3, and R₁ is a C1 to C3 straight chain alkyl group.

According to an exemplary embodiment of the present invention, the polyacryl-based resin may be represented by the following Chemical Formula 3:

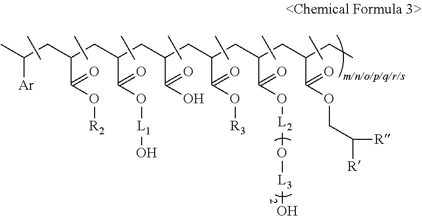

wherein
Ar is aryl, R₂ and R₃ are independently of each other C1 to C4 straight chain or branched chain alkyl, L₁ to L₃ are independently of one another C1 to C4 straight chain or branched chain alkylene, R′ and R″ are independently of each other C1 to C4 straight chain or branched chain alkyl, m is 0 to 1,000, n is 1 to 1,000, o is an integer of 0 to 100, p and s are integers of 0 to 100, and o and r are not 0 at the same time.

According to an exemplary embodiment of the present invention, the polyacryl-based resin may be represented by the following Chemical Formula 4:

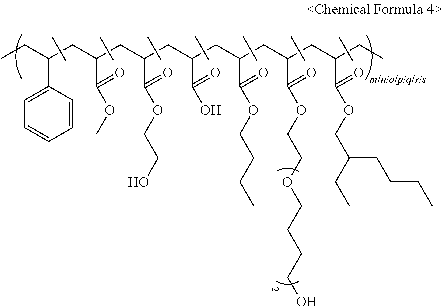

wherein
m is 0 to 1,000, n is 1 to 1,000, o is an integer of 0 to 100, p is an integer of 0 to 100, q and s are integers of 0 to 100, and o and r are not 0 at the same time.

According to an exemplary embodiment of the present invention, the multi-functional alcohol may be synthesized by reacting a precursor including the hindered urea structure formed by reacting a hindered diamine and a multi-functional isocyanate, and a chained or branched diol.

According to an exemplary embodiment of the present invention, the hindered diamine may be N,N′-di-tert-butylethylenediamine or bis(2,2,6,6-tetramethyl-4-piperidyl) sebacate) sebacate.

According to an exemplary embodiment of the present invention, the multi-functional isocyanate may include isophorone diisocyanate (IPDI).

According to an exemplary embodiment of the present invention, the chained or branched diol may include ethylene glycol, tetraethylene glycol, and pentaethylene glycol.

According to an exemplary embodiment of the present invention, the precursor including the hindered urea structure may include structures of the following Chemical Formulae 5A and 5B:

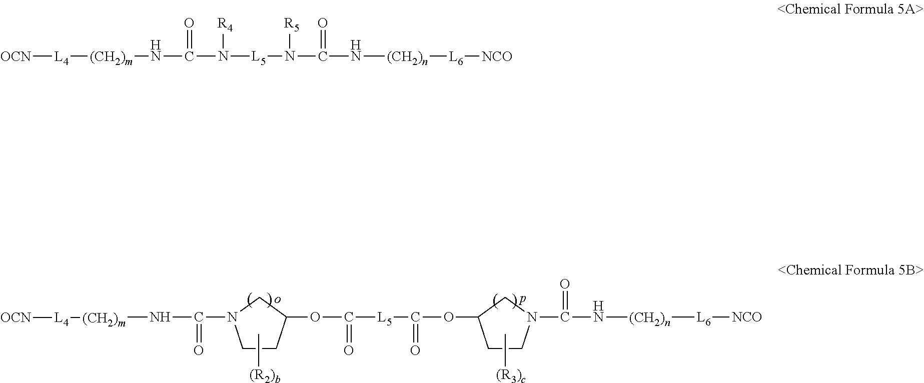

wherein
m and n are 1 to 5, o and p are 1 to 3, b and c are 1 to 5, L₅ is C1 to C10 alkylene, L₄ and L₆ are any one selected from the group consisting of C1 to C10 alkylene and cycloalkylene, the cycloalkylene of L₄ and L₆ may be further substituted by C1 to C10 alkyl, R₂ and R₃ are an alkyl group, and R₄ and R₅ are C4 to C7 branched chain alkyl.

According to an exemplary embodiment of the present invention, the precursor including the hindered urea structure may include structures of the following Chemical Formulae 6A to 6D:

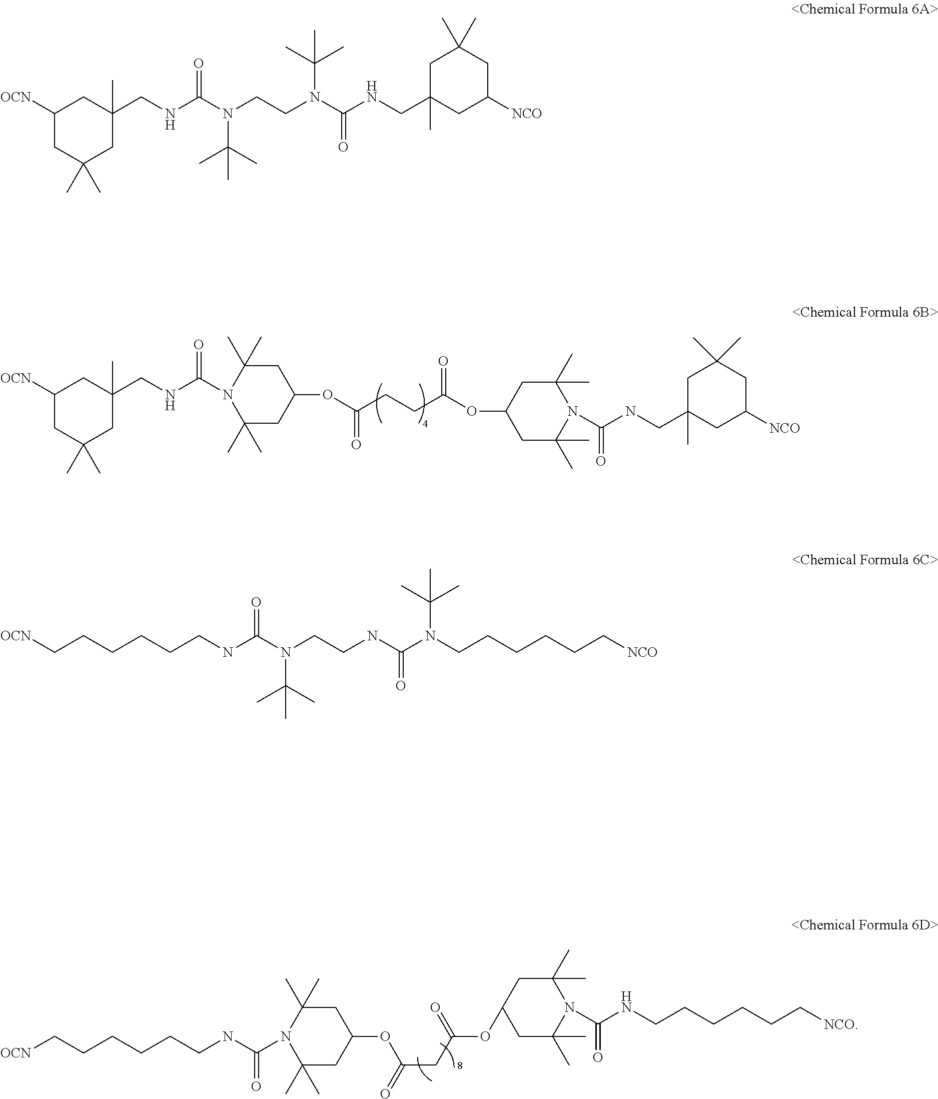

According to an exemplary embodiment of the present invention, the multi-functional alcohol may include structures of the following Chemical Formulae 7A and 7B:

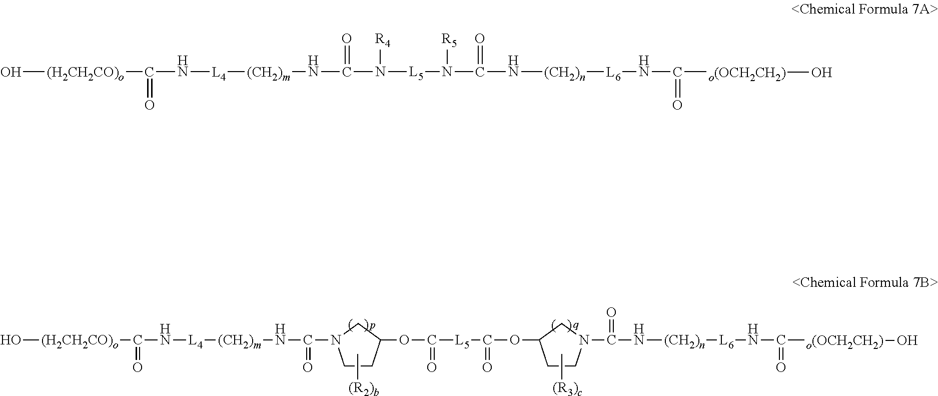

wherein
b, c, m, and n are 1 to 5, o is 1 to 4, p and q are 1 to 3, L5 is C1 to C10 alkylene, L₄ and L₆ are any one selected from the group consisting of C1 to C10 alkylene and cycloalkylene, the cycloalkylene of L₄ and L₆ may be further substituted by C1 to C10 alkyl, R₂ and R₃ are an alkyl group, and R₄ and R₅ are C4 to C7 branched chain alkyl.

According to an exemplary embodiment of the present invention, the multi-functional alcohol may include the following Chemical Formulae 8A to 8D:

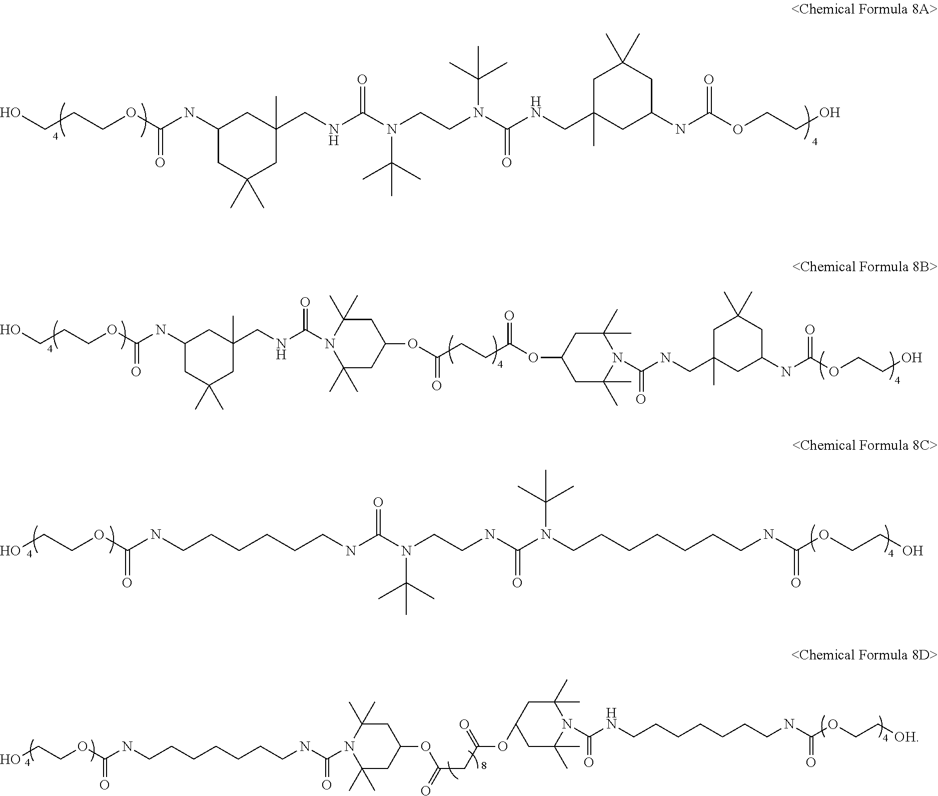

In an exemplary embodiment of the present invention, the photothermal dye may include a chemical structure represented by the following Chemical Formula 9:

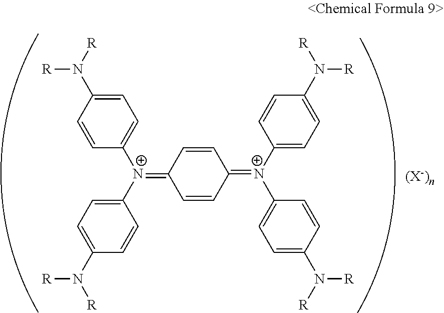

wherein
R is the same as or different from each other and one consisting of a hydrogen atom, an alkyl group, an aryl group, an alkoxy group, a hydroxyl group, a phenyl group, or a halogenated alkyl group, X is an anion, and n is 1 or 2.

In an exemplary embodiment of the present invention, the anion may include bis(oxalato)borate.

In an exemplary embodiment of the present invention, the crosslinking agent including hydroxyl group or isocyanate group may include a chemical structure represented by the following Chemical Formula 10:

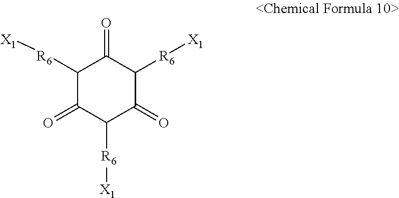

wherein R₆ is independently of each other a C1 to C6 alkyl group, and X₁ is an isocyanate group or hydroxyl group.

In an exemplary embodiment of the present invention, the multi-functional alcohol may be included at 5 to 50 parts by weight with respect to 100 parts by weight of the polyacryl-based resin.

In an exemplary embodiment of the present invention, the crosslinking agent including hydroxyl group or isocyanate group may be included at 25 to 55 parts by weight with respect to 100 parts by weight of the polyacryl-based resin.

In an exemplary embodiment of the present invention, the photothermal dye may be included at 0.01 to 0.50 wt %.

In another general aspect, a clearcoat having a topical self-healing function formed by a crosslinking reaction of the topical self-healing transparent coating composition is provided.

According to an exemplary embodiment of the present invention, the topical clearcoat may have a thermal decomposition temperature (T_{d}) of 235 to 260° C.

According to an exemplary embodiment of the present invention, the clearcoat may have a glass transition temperature (T_{g}) of 20 to 60° C.

According to an exemplary embodiment of the present invention, the clearcoat may have a near-infrared and visible light transmittance of 90% or more.

According to an exemplary embodiment of the present invention, the clearcoat may have an indentation modulus of 2 to 8 GPa.

According to an exemplary embodiment of the present invention, the clearcoat may have an indentation hardness of 110 to 130 MPa.

### Advantageous Effects

The clearcoat including a multi-functional crosslinking agent having a structure including a hindered urea structure and an alkylene oxide repeating unit according to the present invention may self-heal fine scratches in a short time by using a reversible bond occurring at a high temperature, and may have excellent solvent resistance and mechanical properties of a coating.

In addition, since a photothermal dye absorbs light in the near infrared (NIR) region to generate heat, whereby sunlight is concentrated with NIR laser or a magnifying glass to irradiate only a scratched area to allow self-healing, there is an economical benefit to impart long-term stability to the clearcoat.

### DESCRIPTION OF DRAWINGS

FIG. 1 shows results of 1H-NMR analysis for a precursor of a multi-functional alcohol including a hindered urea structure of Preparation Example 1 of the present invention.

FIG. 2 shows results of FT-IR analysis for a precursor of a multi-functional hindered urea alcohol to the precursor of a multi-functional alcohol including a hindered urea structure of Preparation Example 1 of the present invention.

FIG. 3 shows results of 1H-NMR analysis for the multi-functional alcohol according to Preparation Example 2 of the present invention.

FIG. 4 shows results of FT-IR analysis for the multi-functional alcohol according to Preparation Example 2 of the present invention.

FIG. 5 shows results of quantitative analysis of mechanical properties of clear coating materials prepared according to Comparative Examples 1 and 5 of the present invention using TGA equipment.

FIG. 6 shows results of quantitative analysis of mechanical properties of clear coating materials prepared according to Comparative Examples 1 and 5 of the present invention using DSC equipment.

FIG. 7 shows results of analysis of penetration depth upon indentation and indentation hardness using nanoindentation equipment, as mechanical properties of the clear coating material prepared according to Comparative Example 1 of the present invention.

FIG. 8 shows results of analysis of indentation hardness and indentation elastic modulus using nanoindentation equipment, as mechanical properties of the clear coating materials prepared according to Comparative Examples 1 and 5 of the present invention.

FIG. 9 shows results of quantitative analysis of transparency of the clear coating materials of Comparative Examples 2 to 5 prepared according to an exemplary embodiment of the present invention, using a spectrophotometer.

FIG. 10 shows results of quantitative analysis of transparency of the clear coating materials of Comparative Example 1 and Examples 1 to 3 prepared according to an exemplary embodiment of the present invention, using a spectrophotometer.

FIG. 11 shows clearcoats obtained by coating a slide glass with the clearcoats of Comparative Examples 2 to 5 prepared according to an exemplary embodiment of the present invention, using a bar coater.

FIG. 12 shows clearcoats obtained by coating a slide glass with the clearcoats of Comparative Example 1 and Examples 1 to 3 prepared according to an exemplary embodiment of the present invention, using a bar coater.

FIG. 13 is a drawing which comprehensively shows self-healing efficiency of the coating materials of Examples 1 to 3 and Comparative Examples 1 to 5 prepared according to the present invention.

FIG. 14 shows a self-healing effect after scratching a clearcoat without the photothermal dye of Comparative Example 1 with a force of 50 mN.

FIG. 15 shows a self-healing effect after scratching a clearcoat including the photothermal dye of Example 2 with a force of 50 mN.

FIG. 16 shows a self-healing effect after scratching a clearcoat without the multi-functional alcohol and the photothermal dye of Comparative Example 5 with a force of 50 mN.

FIG. 17 shows the repetitive self-healing effect of Example 2.

FIG. 18 shows the repetitive self-healing effect of Comparative Example 3.

FIG. 19 shows a self-healing effect by sunlight of a model automobile to which the coating of Example 2 of the present invention was applied.

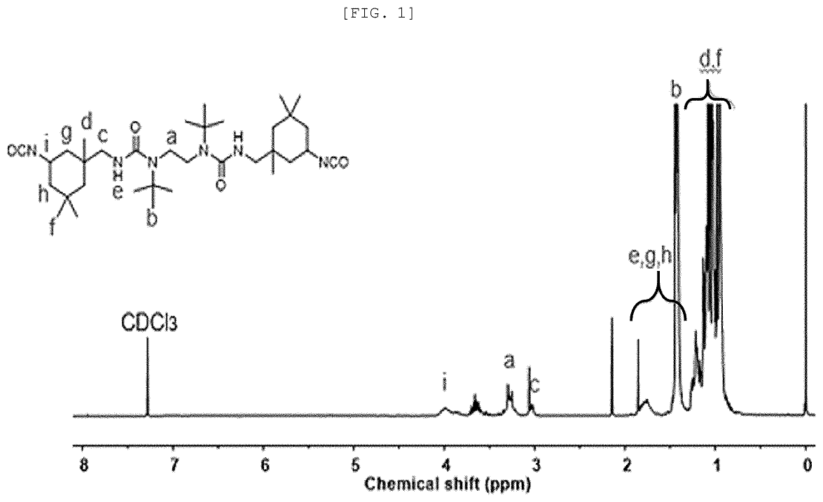

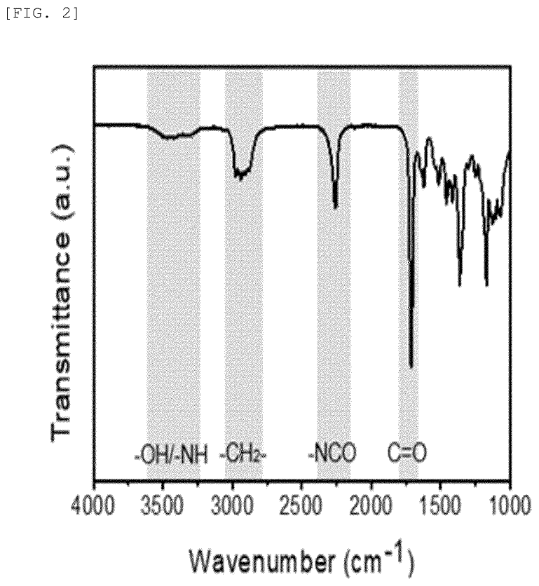

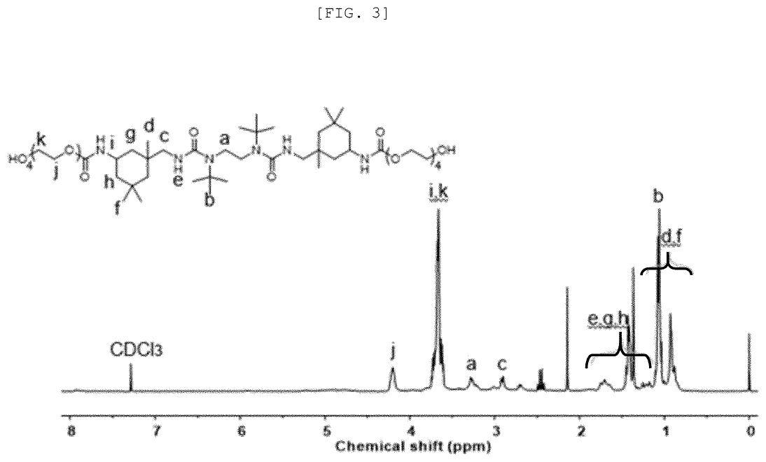

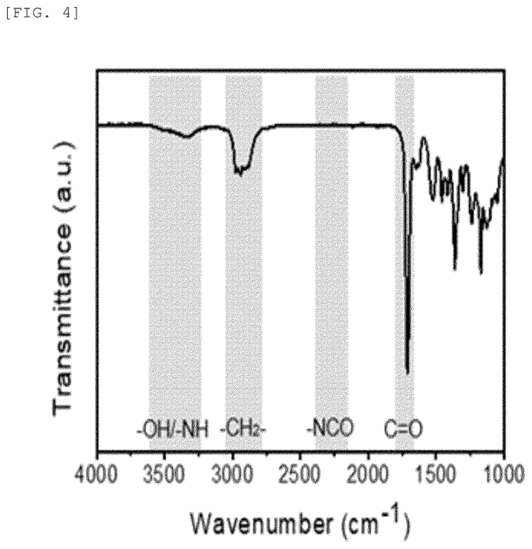

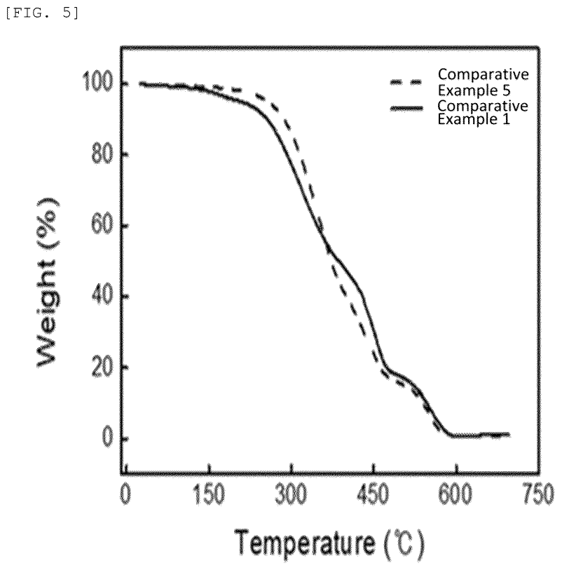

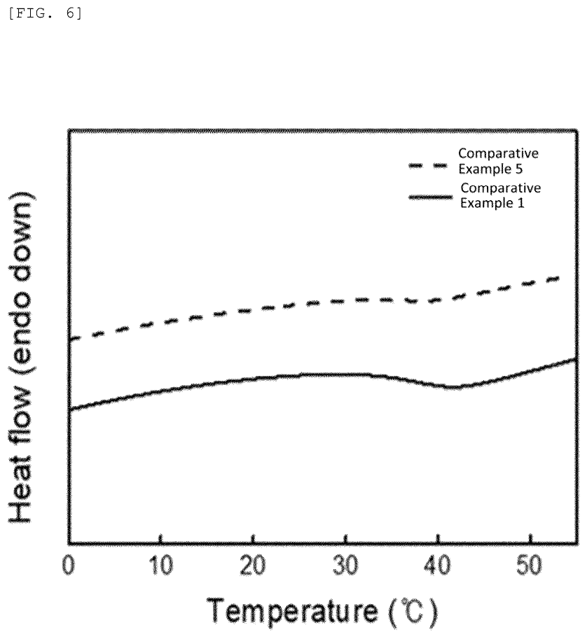

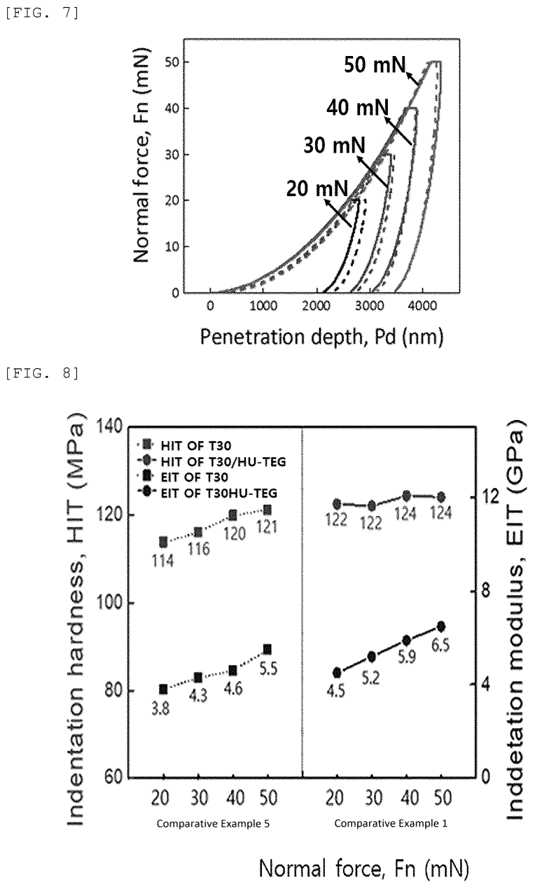

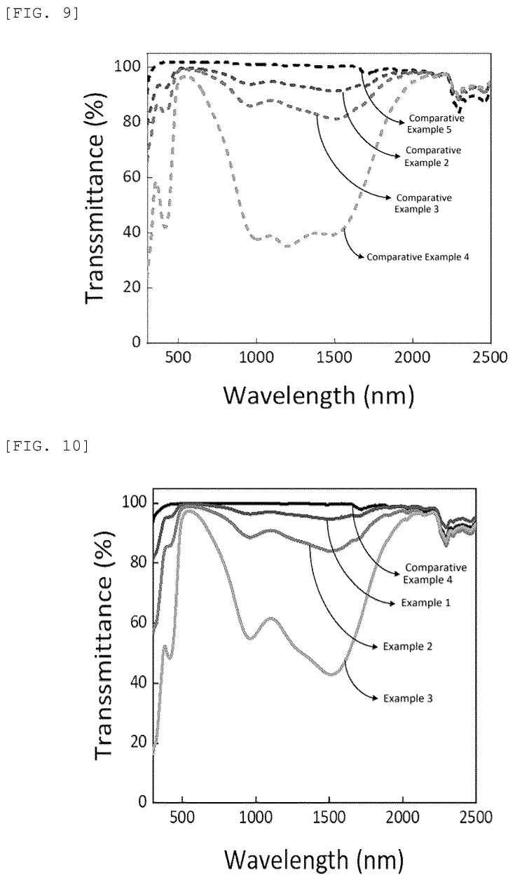

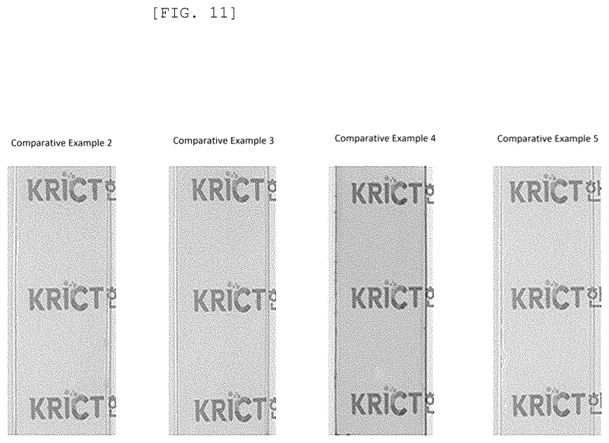

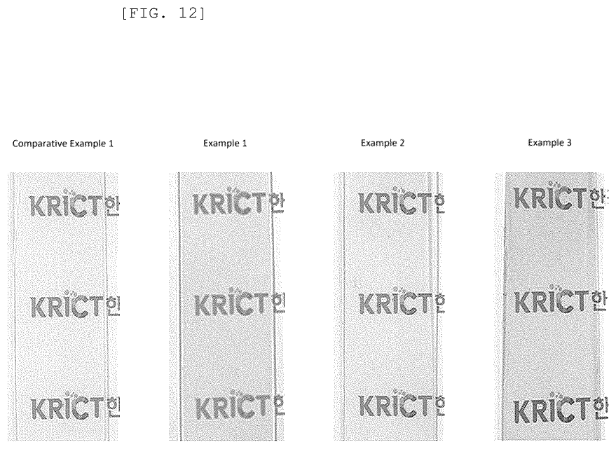

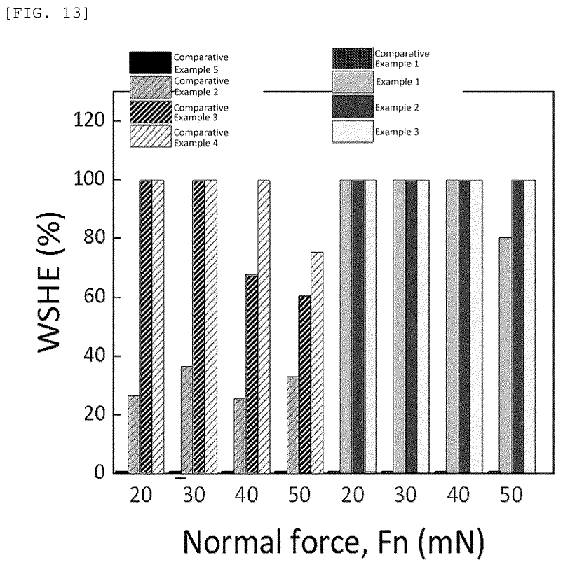

### BEST MODE

Hereinafter, the present invention will be described in detail. Terms and words used in the present specification and claims are not to be construed as a general or dictionary meaning but are to be construed as meaning and concepts meeting the technical ideas of the present invention based on a principle that the inventors can appropriately define the concepts of terms in order to describe their own inventions in best mode.

The term “self-healing” used throughout the present specification refers to an ability to heal back (recover) to its original state automatically and autonomously without any external interference with damaged material, in a broad sense, and recovery of damage by external force to its original state to some extent, in a narrow sense.

The present invention relates to a topical self-healing transparent coating composition including: a polyacryl-based resin including a hydroxyl group at the end of a side chain;
a multi-functional alcohol including two or more hindered urea structures in the molecule and a hydroxyl group at both ends of the molecule; a crosslinking agent including hydroxyl group or isocyanate group; and a photothermal dye compound.

According to an exemplary embodiment of the present invention, it is preferred that a hydroxyl group content of the multi-functional alcohol may be 5 to 50 mol %, specifically 10 to 40 mol %, of the total hydroxyl group content of the coating composition including the hydroxyl group of polyacrylate, the hydroxyl group of the multi-functional alcohol, and the of the hydroxyl group crosslinking agent.

According to another exemplary embodiment of the present invention, it is preferred that an isocyanate group content of the crosslinking agent is at a mole ratio of 0.8 to 1.2 to the total hydroxyl group content of the coating composition including the hydroxyl group of the polyacrylate, the hydroxyl group of the multi-functional alcohol, and the hydroxyl group of the crosslinking agent.

Since the hydroxyl group of the multi-functional alcohol and the isocyanate group of the crosslinking agent are included at the above contents with respect to the total hydroxyl groups, the self-healing properties and hard properties of the clearcoat prepared by the present coating composition may be adjusted.

The hindered urea structure including the multi-functional alcohol of the present invention may include a structure of the following Chemical Formula 1 or Chemical Formula 2:

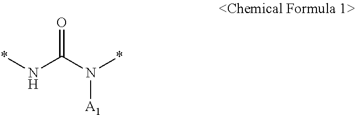

wherein A₁ is a C1 to C10, specifically, C4 to C7 branched chain alkyl group,

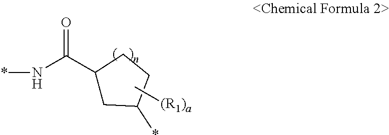

wherein a is 1 to 7, specifically 1 to 4, n is 1 to 5, specifically 1 to 3, and R₁ is a C1 to C7, specifically C1 to C3 straight chain alkyl group.

Since the multi-functional alcohol of the present invention includes the hindered urea functional group, a urea bond is reversibly formed by heat generated by the photothermal dye compound to cause the self-healing effect of the coating.

The multi-functional alcohol according to an exemplary embodiment of the present invention may be prepared by preparing a precursor including a hindered urea structure prepared by reacting the amine group of hindered diamine and the isocyanate group of the multi-functional isocyanate at an equivalent of 1:5 to 1:3, specifically 1:4 to 1:3, preferably 1:2, and then reacting a chained or branched diol.

The chained or branched diol may be an aliphatic diol, specifically diol, triol, or tetraol having a total of 3 to 15 carbon atoms, and more specifically, ethylene glycol, triethylene glycol, or a compound including at least two ether groups in a molecular structure such as ethylene glycol and triethylene glycol. Since the chained or branched diol increases flexibility in the clearcoat by including a chain structure repeating unit in the crosslinked structure and has improved solubility in a solvent by including an ether group, it has a process benefit when preparing the clearcoat with the coating composition.

The hindered diamine may be any one of N,N′-di-tert-butylethylenediamine or (bis(2,2,6,6-tetramethyl-4-piperidyl) sebacate, and the multi-functional isocyanate is any one of aliphatic, aromatic, alicyclic, or aromatic aliphatic compounds and may contain two or more isocyanate groups in the molecular structure.

The aliphatic multi-functional isocyanate compound may be one or more aliphatic isocyanates selected from the group consisting of ethylene diisocyanate, trimethylene diisocyanate, tetramethylene diisocyanate, hexamethylene diisocyanate (HMDI), octamethylene diisocyanate, nonamethylene diisocyanate, dodecamethylene diisocyanate, 2,2-dimethylpentane diisocyanate, 2,2,4-trimethyl hexamethylene diisocyanate, decamethylene diisocyanate, butene diisocyanate, 1,3-butadiene-1,4-diisocyanate, 2,4,4-trimethyl hexamethylenediisocyanate, 1,6,11-undecane triisocyanate, 2,2,4-trimethylhexamethylene diisocyanate, lysine diisocyanate, 2,6-diisocyanatemethyl caproate, bis(2isocyanatoethyl) fumarate, bis(2-isocyanatoethyl) carbonate, 1,3,6-2-isocyanateethyl-2,6-diisocyanatohexanoate, hexamethylene triisocyanate, 1,8-diisocyanato-4-isocyanatomethyl octane, 2,5,7-trimethyl-1,8-diisocyanato-5-isocyanatomethyl octane, bis(isocyanatoethyl) carbonate, bis(isocyanatoethyl) ether, 1,4-buthyene glycol dipropyl ether-ω,ω′-diisocyanate, lysine diisocyanato methylester, lysine triisocyanate, 2-isocyanatoethyl-2,6-diisocyanato ethyl-2,6-diisocyanato hexanoate, 2-isocyanatopropyl-2,6-diisocyanato hexanoate, xylylene diisocyanate, bis(isocyanatoethyl)benzene, bis(isocyanato propyl)benzene, α,α,α′,α′-tetramethyl xylylene diisocyanate, bis(isocyanatobutyl)benzene, bis(isocyanatomethyl) naphthalene, bis(isocyanatomethyl) diphenyl ether, bis(isocyanatoethyl) phthalate, 2,6-di(isocyanatomethyl) furan, 1,3,-bis(6-isocyanatohexyl)-uretidin-2,4-dione, and 1,3,5-tris(6-isocyanatohexyl) isocyanurate.

The alicyclic multi-functional isocyanate compound may be one or more alicyclic isocyanate selected from the group consisting of isophorone diisocyanate (IPDI), 4,4′-dicyclohexylmethane diisocyanate, cyclohexylene diisocyanate, methylcyclohexylene diisocyanate, bis(2-isocyanateethyl)-4-cyclohexene-1,2-dicarboxylate, 2,5-norbornane diisocyanate, 2,6-norbornane diisocyanate, 2,2-dimethyl dicyclohexylmethane diisocyanate, bis(4-isocyanato-n-butylidene) pentaerythritol, dimeric acid diisocyanate, 2-isocyanatomethyl-3-(3-isocyanatopropyl)-5-isocyanatomethyl-bicyclo[2,2,1]-heptane, 2-isocyanatomethyl-3-(3-isocyanatopropyl)-6-isocyanatomethyl-bicyclo[2,2,1]-heptane, 2-isocyanatomethyl-2-(3-isocyanatopropyl)-5-isocyanatomethyl-bicyclo[2,2,1]-heptane, 2-isocyanatomethyl-2-(3-isocyanatopropyl)-6-isocyanatomethyl-bicyclo[2,2,1]-heptane, 2-isocyanatomethyl-3-(3-isocyanatopropyl)-6-(2-isocyanato ethyl)-bicyclo[2,2,1]-heptane, 2-isocyanatomethyl-3-(3-isocyanatopropyl)-6-(2-isocyanatoethyl)-bicyclo[2,1,1]-heptane, 2-isocyanatomethyl-2-(3-isocyanatopropyl)-5-(2-isocyanatoethyl)-bicyclo[2,1,1]-heptane, 2-isocyanatomethyl-2-(3-isocyanatopropyl)-6-(2-isocyanatoethyl)-bicyclo[2,2,1]-heptane, and norbornane bis(isocyanatomethyl).

The aromatic aliphatic multi-functional isocyanate compound may be one or more aromatic aliphatic isocyanates selected from the group consisting of 1,3-bis(isocyanatomethyl)benzene (m-xylene diisocyanate (m-XDI), 1,4-bis(isocyanatomethyl)benzene (p-xylene diisocyanate (p-XDI), 1,3-bis(2-isocyanatopropane-2-yl)benzene (m-tetramethyl xylene diisocyanate (m-TMXDI), 1,4-bis(2-isocyanatopropane-2-yl)benzene (p-tetramethyl xylene diisocyanate (p-TMXDI), 1,3-bis(isocyanato methyl)-4-methylbenzene, 1,3-bis(isocyanatomethyl)-4-ethylbenzene, 1,3-bis(isocyanatomethyl)-5-methylbenzene, 1,3-bis(isocyanatomethyl)-4,5-dimethylbenzene, 1,4-bis(isocyanato methyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chloro benzene, 1,3-bis(isocyanatomethyl)-4,5-dichlorobenzene, 1,3-bis(isocyanatomethyl)-2,4,5,6-tetrachloro benzene, 1,4-bis(isocyanatomethyl)-2,3,5,6-tetrachloro benzene, 1,4-bis(isocyanatomethyl)-2,3,5,6-tetrabromobenzene, 1,4-bis(2-isocyanatoethyl)benzene, and 1,4-bis(isocyanatomethyl) naphthalene.

It is preferred that the multi-functional isocyanate is any one of hexamethylene diisocyanate (HMDI) and isophorone diisocyanate (IPDI).

The precursor including the hindered urea structure according to an exemplary embodiment of the present invention may be specifically represented by the following Chemical Formula 5A or Chemical Formula 5B, and more specifically, may be Chemical Formula 6A to Chemical Formula 6D:

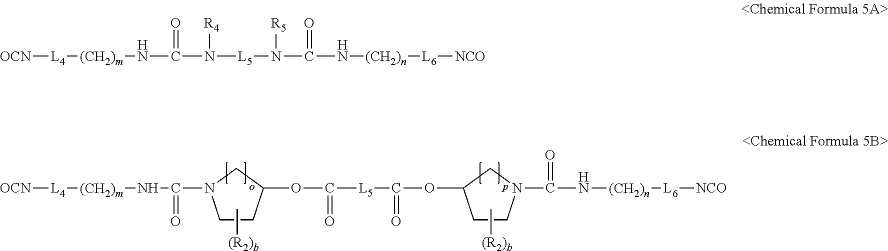

wherein
m and n are 1 to 7, specifically 1 to 5, o and p are 1 to 5, specifically 1 to 3, b and c are 1 to 7, specifically 1 to 5, L₅ is C1 to C15, specifically C1 to C10 alkylene, L₄ and L₆ are any one selected from the group consisting of C1 to C15, specifically C1 to C10 alkylene and cycloalkylene, the cycloalkylene of L4 and L6 may be further substituted by C1 to C15, specifically, C1 to C10 alkyl, R₂ and R₃ are a C1 to C5, specifically C1 to C3 alkyl group, and R₄ and R₅ are C4 to C10, specifically C4 to C7 branched chain alkyl,

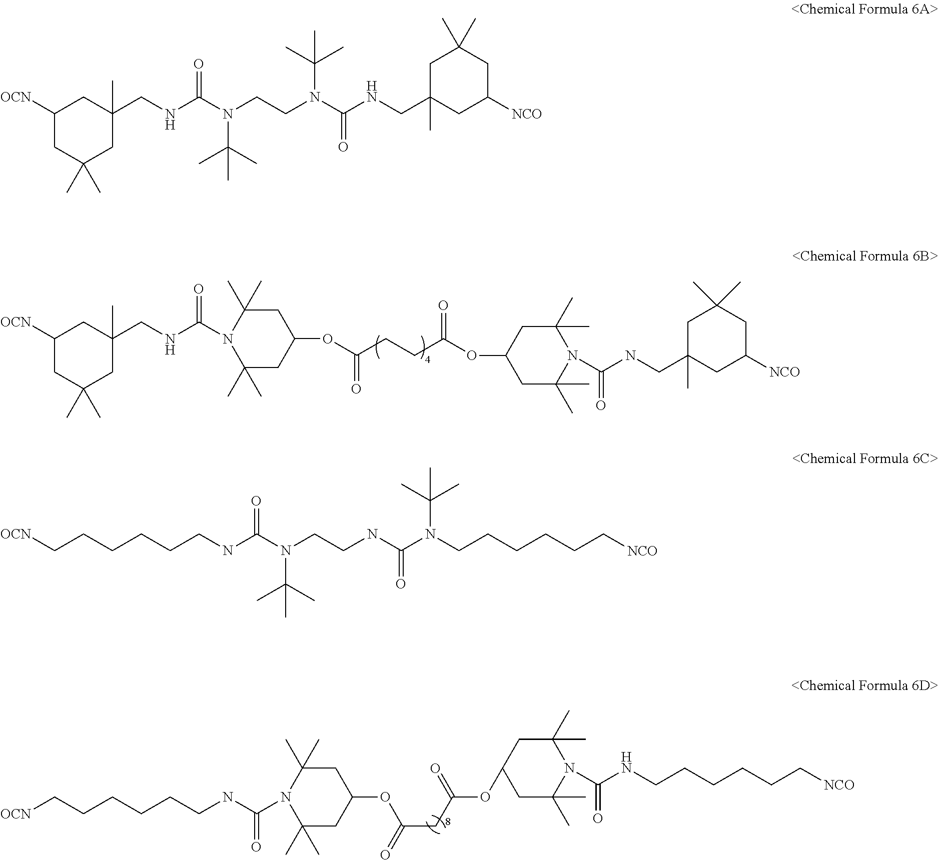

According to an example of the present invention, the multi-functional alcohol formed by reacting the precursor including the hindered urea structure and the chained or branched diol may include a structure of the following Chemical Formula 7A or 7B, more specifically structures of Chemical Formulae 8A to 8D:

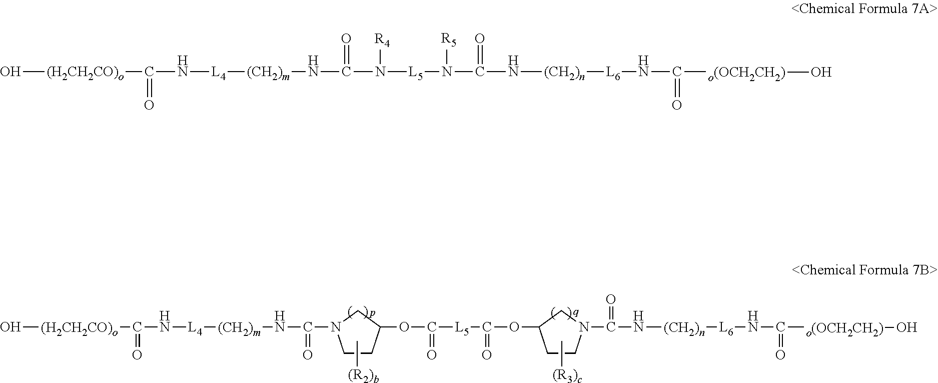

wherein
m and n are 1 to 7, specifically 1 to 5, b and c are 1 to 7, specifically 1 to 5, o is 1 to 6, specifically 1 to 4, p and q are 1 to 5, specifically 1 to 3, L₅ is C1 to C15, specifically C1 to C10 alkylene, L₄ to L₆ are any one selected from the group consisting of C1 to C15, specifically C1 to C10 alkylene and cycloalkylene, the cycloalkylene of L₄ and L₆ may be further substituted by C1 to C15, specifically C1 to C10 alkyl, and R₄ and R₅ are C4 to C10, specifically C4 to C7 branched chain alkyl,

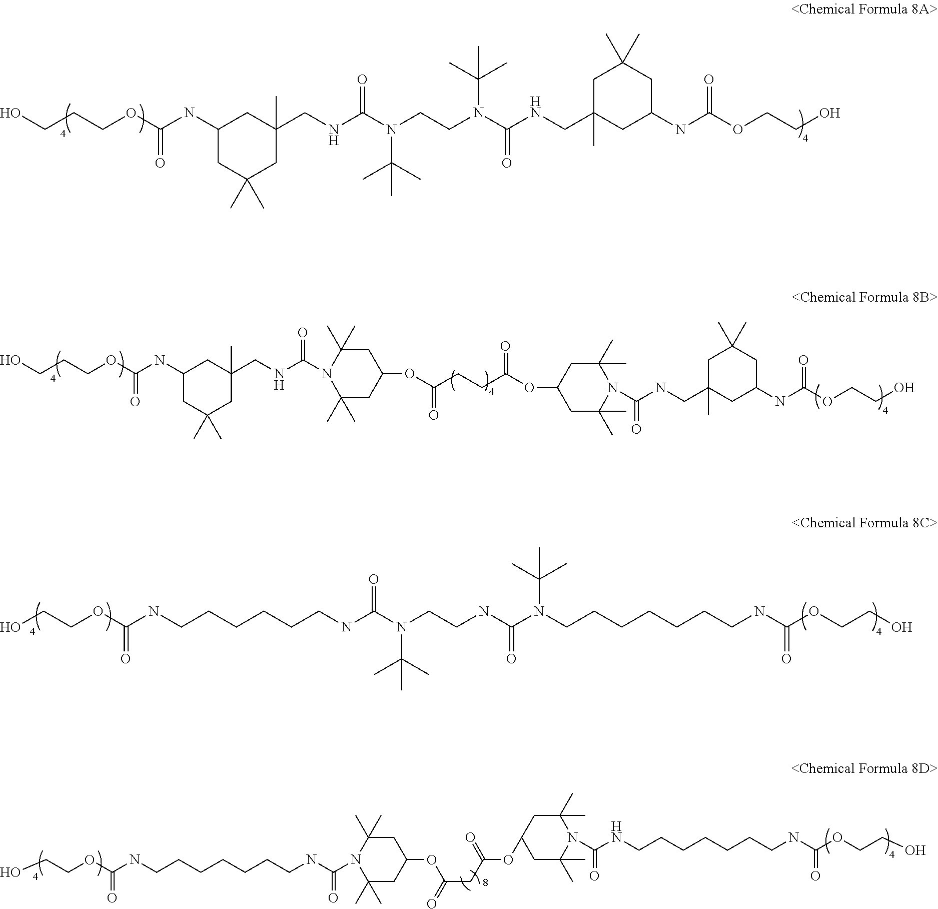

The polyacryl-based resin according to an example of the present invention may be usually polyacrylate resin, polymethacrylate resin, and a homopolymer or copolymer resin including various acrylate and methacrylate monomers, and preferably include a hydroxyl group (—OH) at the end of the side chain. Specifically, the polyacryl-based resin may be represented by the following Chemical Formula 3, and more specifically, may have a structure represented by the following Chemical Formula 4:

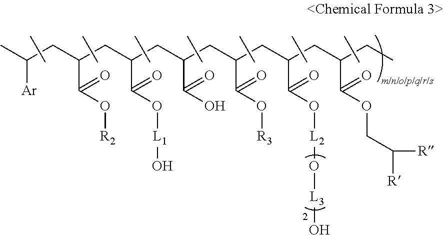

wherein m is 0 to 2,000, specifically 0 to 1000, n is 1 to 2000, specifically 1 to 1000, o to s are an integer of 0 to 200, specifically 0 to 100, o and r are not 0 at the same time, Ar is aryl, R₂ and R₃ are independently of each other C1 to C7, specifically C1 to C4 alkyl, L₁ to L₃ are independently of one another C1 to C4, specifically C2 and C3 alkylene, and R′ and R″ are independently of each other C1 to C7, specifically C1 to C4 alkyl,

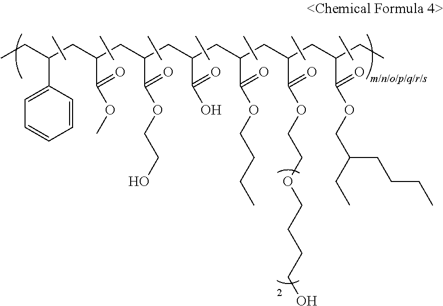

wherein m is 0 to 2,000, specifically 0 to 1000, n is 1 to 2000, specifically 1 to 1000, o to s are an integer of 0 to 200, specifically 0 to 100, and o and r are not 0 at the same time.

According to an example of the present invention, the coating composition of the present invention may include a crosslinking agent including a: hydroxyl group or an isocyanate group. The crosslinking agent has an effect of imparting hard properties to the coating composition of the present invention, and the type of crosslinking agent may be an acryl-based polymer and an aliphatic aromatic compound including a hydroxyl group or an isocyanate group, but is not limited thereto.

An example of the crosslinking agent including a hydroxyl group or an isocyanate group may include polyethylene glycol, polypropylene glycol, polybutiandiol, glycerine, monoethanolamine, diethanolamine, triethanolamine, trimethylol propane, pentaaerythritol, oxypropylated ethylene diamine, xylylene diisocyanate (XDI), tolylene diisocyanate (TDI), tetramethylene diisocyanate, hexamethylene diisocyanate (HMDI), isophorone diisocyanate (IPDI), hydrogenated tolylene diisocyanate, diphenylmethanediisocyanate, hydrogenated diphenylmethane di isocyanate, and a polyisocyanate compound or isocyanurated compound in which trimethylolpropane and the like are added to those compounds, an additive compound, polyether polyol or polyester polyol known in the art, acrylpolyol, polybutadiene polyol, and the like.

According to an example of the present invention, the crosslinking agent including a hydroxyl group or an isocyanate group may include the following Chemical Formula 10:

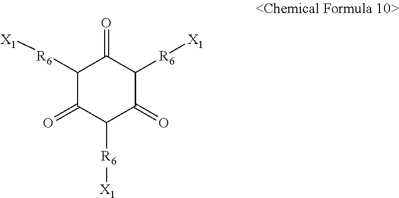

wherein R₆ is independently of each other a C1 to C10, specifically C1 to C6 alkyl group, and X₁ is an isocyanate group or a hydroxyl group.

The photothermal dye according to an exemplary embodiment of the present invention may include a diammonium-based dye. The diammonium dye has an effect of forming a crosslink in a reversible self-healing system of the coating composition by generating high-temperature heat by absorbing light in the near-infrared (NIR) region.

It is preferred that the photothermal dye may specifically use a compound having a maximum absorption wavelength at 850 to 1500 nm shown in the following Chemical Formula 9. The maximum absorption wavelength may be 1000 to 1500 nm, more specifically 1000 to 1400 nm.

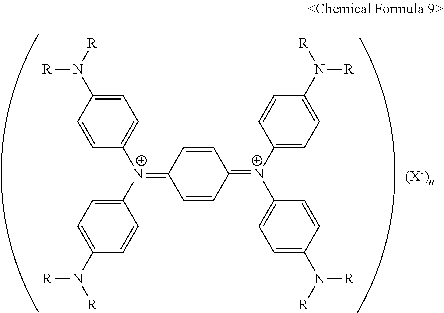

R is the same as or different from each other and one consisting of a hydrogen atom, an alkyl group, an aryl group, an alkoxy group, a hydroxyl group, a phenyl group, or a halogenated alkyl group, X is a monovalent or divalent organic or inorganic anion, and n is 1 or 2.

R may be, as an alkyl group, a straight chain, branched chain, or alicyclic alkyl group having 1 to 20 carbon atoms, such as a methyl group, an ethyl group, an n-propyl group, an iso-propyl group, an n-butyl group, an iso-butyl group, a sec-butyl group, a t-butyl group, an n-pentyl group, an iso-pentyl group, a neo-pentyl group, a cyclopentyl group, a 1,2-dimethyl propyl group, an n-hexyl group, a cyclohexyl group, a 1,3-dimethyl butyl group, a 1-iso-propyl propyl group, a 1,2-dimethyl butyl group, an n-heptyl group, a 1,4-dimethyl pentyl group, a 2-methyl-1-iso-propyl propyl group, a 1-ethyl-3-methyl butyl group, an n-octyl group, a 2-ethyl hexyl group, a 3-methyl 1-isopropyl butyl group, a 2-methyl-1-iso-propyl group, a 1-t-butyl-2-methylpropyl group, an n-nonyl group, a 3,5,5-trimethyl hexyl group, and the like. In addition, it may be, as an aryl group, a phenyl group, a naphthyl group, a tolyl group, a furyl group, a pyridyl group, or the like, and may be, as a halogenated alkyl group, one or more selected from a fluoroalkyl group, a chloroalkyl group, and a bromoalkyl group.

In addition, it may be, as an alkoxy group, a methoxy group, an ethoxy group, a propoxy group, a butoxy group, and the like, respectively, and as an alkoxyalkyl group, one or more selected from a methoxy methyl group, a methoxy ethyl group, an ethoxyethyl, a propoxy ethyl group, a butoxyethyl group, a 3-methoxypropyl group, a 3-ethoxypropyl group, a methoxyethoxymethyl group, an ethoxyethoxyethyl group, a dimethoxymethyl group, a diethoxymethyl group, a dimethoxyethyl group, and a diethoxyethyl group. More specifically, R may be n-butane and X may be bis(oxalate)borate.

The anion may be a known monovalent or divalent organic acid or inorganic acid anion, but is not limited thereto. An example of the anion includes an organic carboxylic acid ion, for example, an acetate ion, a lactate ion, a trifluoroacetate ion, a propionate ion, a benzoate ion, an oxalate ion, a succinate ion, and a stearate ion; an organic sulfonic acid ion, for example, a methanesulfonate ion, a toluene sulfonate ion, a naphthalene monosulfonate ion, a chlorobenzene sulfonate ion, a nitrobenzene sulfonate ion, a dodecylbenzene sulfonate ion, a benzene sulfonate ion, an ethanesulfonate ion, and a trifluoromethane sulfonate ion; and an organic boric acid ion, for example, a tetraphenylborate ion and a bisoxalatoborate ion, a fluoride ion, a chloride ion, a bromide ion, an iodide ion; a thiocyanate ion, a hexafluoroantimonate ion, a perchlorate ion, a periodate ion, a nitrate ion, a tetrafluoroborate ion, a hexafluorophosphate ion, a molybdate ion, a tungstate ion, a titanate ion, a vanadate ion, and a phosphate ion, and according to an example of the present invention, bisoxalatoborate is most preferred as the anion.

The present invention provides a clearcoat having a topical self-healing function, which is prepared with the topical self-healing transparent coating composition.

The high thermal and mechanical properties of the clearcoat having the topical self-healing function are favorable effects occurring due to the fact that the topical self-healing transparent coating composition has a balanced chemical structure including a multi-functional alcohol which is a flexible monomer including an alkylene oxide repeating unit and a hard crosslinking agent including an isocyanate group or a hydroxyl group.

According to an example of the present invention, the clearcoat may have a thermal decomposition temperature (Ta) of 200 to 300° C. Specifically, the thermal decomposition temperature may be 220 to 280° C.

According to an example of the present invention, the clearcoat may have an indentation hardness of 100 to 150 GPa, specifically 110 to 130 GPa.

According to an example of the present invention, the clearcoat may have an indentation modulus of 1 to 10 MPa, specifically 2 to 8 MPa.

According to an example of the present invention, the clearcoat may have a glass transition temperature (T_{g}) of 10 to 70° C., specifically 20 to 60° C. Since the topical self-healing transparent coating composition has the glass transition temperature (T_{g}), a thermoreversible system is operated by heat generated by a photothermal dye to show a self-healing effect.

According to an example of the present invention, the clearcoat may have a near-infrared and visible light transmittance of 80% or more. More specifically, the transmittance may be 90% or more. The topical self-healing transparent coating composition may provide a clearcoat having high quality to maintain a high transmittance and a transparent color, by including a diammonium-based photothermal dye.

Hereinafter, the exemplary embodiments and the examples of the present application will be described in detail so that the preferred examples of the present invention are easily carried out by a person with ordinary skill in the art to which the present application belongs with reference to the attached drawings. In particular, the technical idea and the core configuration and function of the present invention are not limited thereby. In addition, the contents of the present invention may be implemented by various different equipments, and are not limited by the exemplary embodiments and the examples described herein.

### Preparation Example 1

7.74 g (34.82 mol) of isophorone diisocyanate was added to a 250 mL round flask, 20 mL of methyl ethyl ketone was added thereto, and the flask was heated to 35° C. under a nitrogen gas. Next, 3 g (17.41 mmol) of di-tertiary-butylethylenediamine dissolved in 10 mL of methyl ethyl ketone was slowly added dropwise to the flask, and stirring was performed for 2 hours to synthesize a precursor of a multi-functional alcohol including a hindered urea structure.

### Preparation Example 2

6.76 g (34.28 mmol) of tetraethyleneglycol and 0.11 g (0.17 mmol) of dibutyltin dilaurate were added to a 250 mL round flask, 10 mL of methyl ethyl ketone was added thereto, and the flask was heated to 70° C. under a nitrogen gas. Next, the solution was slowly added to the flask of Preparation Example 1, and stirring was performed for 2 hours to prepare a multi-functional alcohol having a hydroxyl group at the end by a chemical bond with tetraethylene glycol having a structure including an ethylene oxide-based repeating unit.

### Preparation Example 3

0.1 g of a photothermal dye was dissolved in 1 mL of methyl ethyl ketone to prepare a stock solution.

### Example 1

A coating composition including 1.43 g of a commercial polyacryl-based resin; 0.27 g of the multi-functional alcohol prepared in Preparation Example 2; a commercial curing agent; and 3.9 μl of photothermal dye (0.05 wt %, Demodur N330, NOROO BEE) was prepared.

### Example 2

A coating composition was prepared in the same manner as in Example 1, except that 7.8 μl (0.10 wt %) of the photothermal dye was included.

### Example 3

A coating composition was prepared in the same manner as in Example 1, except that 39.3 μl (0.50 wt %) of the photothermal dye was included.

### Comparative Example 1

A coating composition was prepared in the same manner as in Example 1, except that no photothermal dye was included.

### Comparative Example 2

A coating composition including 1.43 g of a commercial polyacryl-based resin; 0.33 g of a commercial curing agent; and 3.4 μl (0.05 wt %) of a photothermal dye was prepared.

### Comparative Example 3

A coating composition was prepared in the same manner as in Comparative Example 2, except that 6.8 μl (0.10 wt %) of the photothermal dye was included.

### Comparative Example 4

A coating composition was prepared in the same manner as in Comparative Example 2, except that 33.8 μl (0.50 wt %) of the photothermal dye was included.

### Comparative Example 5

A coating composition including 1.43 g of a commercial polyacryl-based resin and 0.33 g of a commercial curing agent was prepared.

### [Experimental Example 1] Photothermal Experiment of Thermoreversible Clearcoat

A slide glass was coated with the coating compositions of Examples 1 to 3 and Comparative Examples 1 to 5, and then a photothermal experiment was performed.

The photothermal experiment was performed by irradiation with a near-infrared beam under a diameter of 1.5 mm and a height of 15 cm using a near-infrared (NIR) laser having a power of 1 W and a wavelength of 1064 nm, and the temperature of the coating on the slide glass was measured through a thermal imaging camera. The experimental results are shown in the following Tables 1 and 2.

TABLE 1

Example
Photothermal temperature (° C.)

| | Example 1 | Example 2 | Example 3 |
|---|---|---|---|
| Time | (0.05 wt %) | (0.10 wt %) | (0.50 wt %) |

| | | | | |
|---|---|---|---|---|
| (s) | 0 | 26.6 | 26.9 | 28.4 |
| | 10 | 40.4 | 54.3 | 126 |
| | 20 | 44.3 | 60.7 | 139 |
| | 30 | 46.2 | 65.2 | 142 |
| | 40 | 48.2 | 67.9 | 140 |
| | 50 | 49.1 | 70.2 | 137 |
| | 60 | 49.6 | 71.1 | 135 |
| | 90 | 51.3 | 73.8 | 135 |
| | 120 | 52.2 | 75.4 | 133 |
| | 150 | 52.7 | 75.8 | 130 |
| | 180 | 53.1 | 76.2 | 127 |
| | 240 | 54.1 | 78.5 | 125 |
| | 300 | 54.6 | 78.1 | 125 |
| | 360 | 54.7 | 79.0 | 119 |
| | 420 | 54.4 | 79.4 | 120 |
| | 480 | 54.6 | 79.5 | 118 |
| | 540 | 55.4 | 79.7 | 118 |
| | 600 | 55.4 | 79.6 | 120 |

| | | | |
|---|---|---|---|
| Temperature | 28.8 | 52.8 | 113.6 |
| change (° C.) | | | |

TABLE 2

| | | Example | | | | |
|---|---|---|---|---|---|---|
| | | Photothermal temperature (° C.) | | | | |
| | | Comparative | Comparative | Comparative | Comparative | Comparative |
| | | Example 1 | Example 2 | Example 3 | Example 4 | Example 5 |
| Time | | (0.0 wt %) | (0.05 wt %) | (0.10 wt %) | (0.50 wt %) | (0.0 wt %) |
| (s) | 0 | 26.5 | 26.6 | 26.9 | 28.4 | 25.9 |
| | 10 | 28.8 | 40.4 | 54.3 | 126 | 28.1 |
| | 20 | 30.3 | 44.3 | 60.7 | 139 | 29.7 |
| | 30 | 31.3 | 46.2 | 65.2 | 142 | 31.0 |
| | 40 | 31.5 | 48.2 | 67.9 | 140 | 31.6 |
| | 50 | 31.8 | 49.1 | 70.2 | 137 | 32.2 |
| | 60 | 32.3 | 49.6 | 71.1 | 135 | 32.3 |
| | 90 | 32.7 | 51.3 | 73.8 | 135 | 33.1 |
| | 120 | 33.7 | 52.2 | 75.4 | 133 | 33.5 |
| | 150 | 33.7 | 52.7 | 75.8 | 130 | 34.5 |
| | 180 | 33.9 | 53.1 | 76.2 | 127 | 34.5 |
| | 240 | 34.2 | 54.1 | 78.5 | 125 | 34.9 |
| | 300 | 34.3 | 54.6 | 78.1 | 125 | 35.4 |
| | 360 | 33.9 | 54.7 | 79.0 | 119 | 35.6 |
| | 420 | 34.3 | 54.4 | 79.4 | 120 | 35.7 |
| | 480 | 34.5 | 54.6 | 79.5 | 118 | 35.7 |
| | 540 | 34.7 | 55.4 | 79.7 | 118 | 35.2 |
| | 600 | 35.0 | 55.4 | 79.6 | 120 | 35.7 |

| | | | | | |
|---|---|---|---|---|---|
| Temperature | 9.8 | 27.4 | 44.2 | 114.6 | 9.8 |
| change (° C.) | | | | | |

In the above table, Examples 1 to 3 had the highest temperatures of 55.4° C., 79.7° C., and 142° C., respectively, which rose by 28.8° C., 52.8° C., and 113.6° C. from the initial temperatures.

Comparative Example 1 had the highest temperature at 35° C., which was a 9.8° C. rise from the initial starting temperature. Likewise, Comparative Examples 2 to 5 had the highest temperature of 54.1° C., 71.1° C., 141° C., and 35.7° C., respectively, which rose by 27.4° C., 44.2° C., 114.6° C., and 9.8° C. from the initial temperatures.

To summarize Table 1, it was confirmed that the surface temperature of the coating rose rapidly as a laser exposure time was increased in the initial step and then reached a thermal equilibrium state, and also, a difference between room temperature and a coating surface temperature was gradually increased as the content of the photothermal compound was increased.

Therefore, it was confirmed that the temperature rise effect of the coating when the photothermal dye was included was better than the effect when the photothermal dye was not included, and the temperature was linearly increased depending on the content of the photothermal dye.

### [Experimental Example 2] Mechanical Property Test of Clearcoat

The hardness and the elastic modulus of the coating were measured using a nanoindentation (NI) tester for the hardness test of Example 2 and Comparative Example 3. The experimental results are shown in the following Table 3.

TABLE 3

| | Indentation modulus (EIT, MPa) | | | | Indentation hardness (HIT, GPa) | | | |
|---|---|---|---|---|---|---|---|---|
| | 20 mN | 30 mN | 40 mN | 50 mN | 20 mN | 30 mN | 40 mN | 50 m N |
| Example 2 | 122 | 122 | 124 | 124 | 4.5 | 5.2 | 5.9 | 6.5 |
| Comparative | 114 | 116 | 120 | 121 | 3.8 | 4.3 | 4.6 | 5.5 |
| Example 3 | | | | | | | | |

The modulus and the hardness were measured as average values after 5 time experiments. When indenting the coatings of Example 2 and Comparative Example 3 under the loading conditions of 20, 30, 40, and 50 mN, the tendency of increasing hardness (HIT) and elastic modulus (EIT) with increasing indentation strength was confirmed. In addition, it was confirmed that even when the multi-functional alcohol including the hindered urea structure was introduced to the coating of Example 2, the hardness and the elastic modulus were similar to those of the coating of Comparative Example 3 at the same indentation strength.

### [Experimental Example 3] Measurement of Transparency of Clearcoat

A slide glass was coated with Examples 1 to 3 and Comparative Examples 1 to 5, and then their transparency was measured. The transparency was measured by analyzing a transmittance under the conditions from 300 nm to 2500 nm using a spectrophotometer (JASCO V-770). The results are shown in Tables 4 and 5.

TABLE 4

| | Example 1 | Example 2 | Example 3 |
|---|---|---|---|
| | (0.05 wt %) | (0.1 wt %) | (0.50 wt %) |
| Transmittance (%) | 97.8 | 95.1 | 80.9 |

TABLE 5

| | Comparative | Comparative | Comparative | Comparative | Comparative |
|---|---|---|---|---|---|
| | Example 1 | Example 2 | Example 3 | Example 4 | Example 5 |
| | (0.0 wt %) | (0.05 wt %) | (0.1 wt %) | (0.50 wt %) | (0.0 wt %) |
| Transmittance (%) | 99.7 | 97.5 | 94.5 | 79.3 | 99.9 |

The transmittance was an average value of the results of 5-time experiment. In Tables 4-1 and 4-2, as a result of measuring the transmittance, it was confirmed that the transparency of about 90% or more was shown, except the coatings of Example 3 and Comparative Example 4 having the content of the photothermal dye compound of 0.5 wt %.

It was found that as the content of the photothermal dye compound was increased, the transmittance was gradually decreased in both the NIR region (800 to 1900 mm) and the visible light region (350 to 750 nm). In addition, when the content of the photothermal dye compound was more than 0.1 wt %, it was found that the color of the coating was changed to light yellow due to a strong adsorption band in the visible light region.

### [Experimental Example 4] Self-Healing Test of Thermoreversible Clearcoat

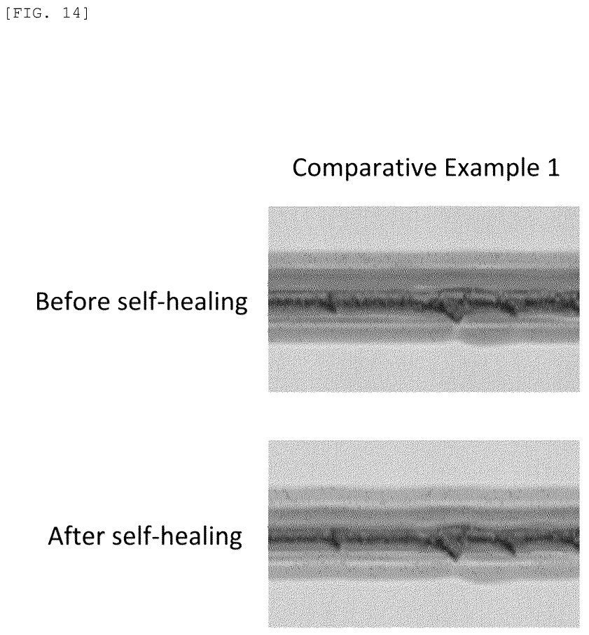

The coating was scratched with a load of 40 mM using a micro scratch tester (MST) for the self-healing test of Example 2 and Comparative Examples 1 and 5, the scratched position was irradiated with 1064 nm NIR laser for 1 minute to allow self-healing due to heat occurrence of the photothermal dye compound, and the recovery of scratch was confirmed by an optical microscope mounted in the MST. The experimental results are shown in the following FIGS. 14 to 16, and in Table 6, self-healing efficiency depending on the load after scratching the coatings of Examples 1 to 3 and Comparative Examples 1 to 5 with the load of 20, 30, 40, or 50 mN and then irradiating the scratched position with 1064 nm NIR layer for 1 minute is shown.

Referring to FIG. 14, in Comparative Example 1 including no photothermal dye, no self-healing effect was shown. It was confirmed that it was because the glass transition temperature of Comparative Example 1 was 38° C., the highest temperature of the system was a lower temperature of 32.3° C., and the polymer was not able to have sufficient flowability.

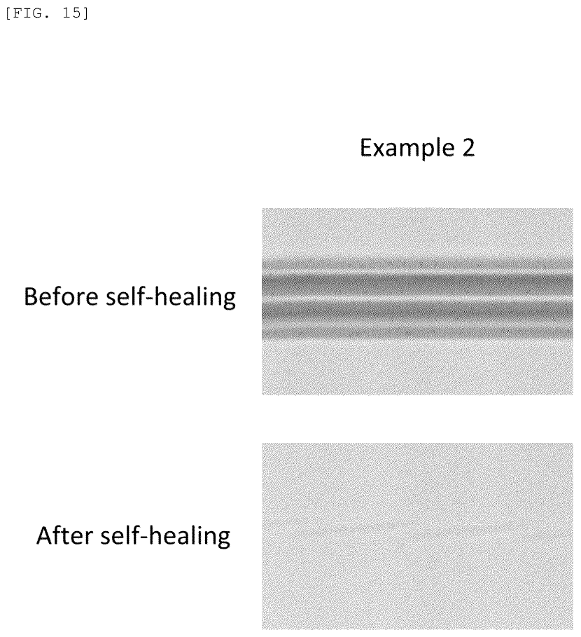

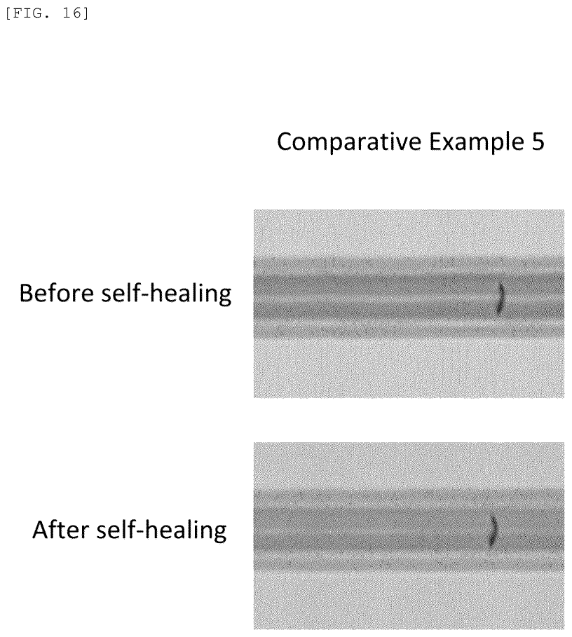

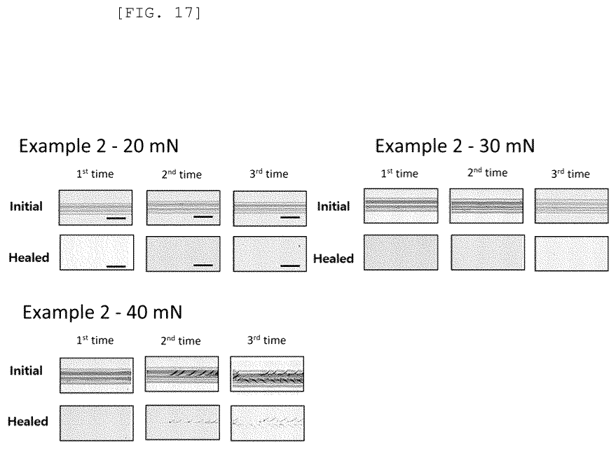

Referring to FIGS. 15 and 16, in Example 2, when a load of 40 mN was applied and then irradiation was performed with NIR layer, a self-healing effect of 100% was shown, but in Comparative Example 5, the multi-functional alcohol and the photothermal dye were not included, and it was confirmed that the self-healing effect was significantly worse than Example 1. It was confirmed that it was because the flowability of the polymer chain was increased at or higher than the glass transition temperature and the self-healing effect was increased due to the reversible bond of the hindered urea group.

TABLE 6

| | |
|---|---|
| Fn | Scratch width (μm) |

| Example | (mN) | initial | final | % WSHE |
|---|---|---|---|---|
| Example 1 | 20 | 22.2 | 0 | 100 |
| | 30 | 25.4 | 0 | 100 |
| | 40 | 29.6 | 0 | 100 |
| | 50 | 32.5 | 6.4 | 80.2 |
| Example 2 | 20 | 20.4 | 0 | 100 |
| | 30 | 24.1 | 0 | 100 |
| | 40 | 29.2 | 0 | 100 |
| | 50 | 33.1 | 0 | 100 |
| Example 3 | 20 | 20.8 | 0 | 100 |
| | 30 | 24.5 | 0 | 100 |
| | 40 | 28.7 | 0 | 100 |
| | 50 | 32.4 | 0 | 100 |
| Comparative | 20 | 19.4 | 19.4 | 0 |
| Example 1 | 30 | 24.1 | 24.1 | 0 |
| | 40 | 31.4 | 31.4 | 0 |
| | 50 | 34.0 | 34.0 | 0 |
| Comparative | 20 | 20.8 | 20.8 | 0 |
| Example 2 | 30 | 25.4 | 25.4 | 0 |
| | 40 | 30.3 | 30.3 | 0 |
| | 50 | 34.0 | 34.0 | 0 |
| Comparative | 20 | 22.2 | 16.3 | 26.6 |
| Example 3 | 30 | 25.4 | 16.1 | 36.6 |
| | 40 | 29.6 | 19.1 | 25.5 |
| | 50 | 31.9 | 21.3 | 33.2 |
| Comparative | 20 | 18.5 | 0 | 100 |
| Example 4 | 30 | 24.1 | 0 | 100 |
| | 40 | 27.8 | 8.9 | 67.8 |
| | 50 | 33.8 | 13.3 | 60.6 |
| Comparative | 20 | 21.7 | 0 | 100 |
| Example 5 | 30 | 27.3 | 0 | 100 |
| | 40 | 30.1 | 0 | 100 |
| | 50 | 33.5 | 8.3 | 75.3 |

### [Experimental Example 5] Self-Healing Repetitive Experiment of Thermoreversible Clearcoat

In order to determine the repetitive self-healing effect of Examples 1 to 3 and Comparative Examples 1 to 5, in Example 2 and Comparative Example 3 having the best transparency and physical properties, the self-healing test was carried out identically using the micro scratch tester (MST), and at this time, heat occurring by the photothermal dye compound was measured using a thermal imaging camera. The measurement results are shown in Tables 7 and 8.

TABLE 7
Results of photothermal repetition test of coating of Example 2

Number of repetitions

| | Time (s) | 1 | 2 | 3 | 4 |
|---|---|---|---|---|---|
| Temperature | 0 | 23.0 | 22.9 | 22.2 | 25.2 |
| (° C.) | 10 | 52.6 | 53.3 | 51.0 | 50.8 |
| | 20 | 56.3 | 56.8 | 57.5 | 57.4 |
| | 30 | 60.9 | 59.5 | 60.8 | 58.4 |
| | 40 | 62.2 | 61.6 | 63.8 | 62.1 |
| | 50 | 64.0 | 62.5 | 64.8 | 64.2 |
| | 60 | 66.8 | 65.4 | 66.9 | 65.9 |

TABLE 8
Results of photothermal repetition test
of coating of Comparative Example 3

| | |
|---|---|
| Comparative | Number of repetitions |

| Example 3 | Time (s) | 1 | 2 | 3 | 4 |
|---|---|---|---|---|---|
| Temperature | 0 | 23.0 | 25.3 | 25.5 | 23.7 |
| (° C.) | 10 | 58.9 | 58.3 | 55.9 | 54.6 |
| | 20 | 64.0 | 64.1 | 63.0 | 61.5 |
| | 30 | 67.5 | 67.7 | 67.6 | 65.2 |
| | 40 | 70.4 | 70.2 | 70.4 | 68.1 |
| | 50 | 72.2 | 71.0 | 72.7 | 71.0 |
| | 60 | 73.6 | 72.2 | 73.7 | 72.6 |

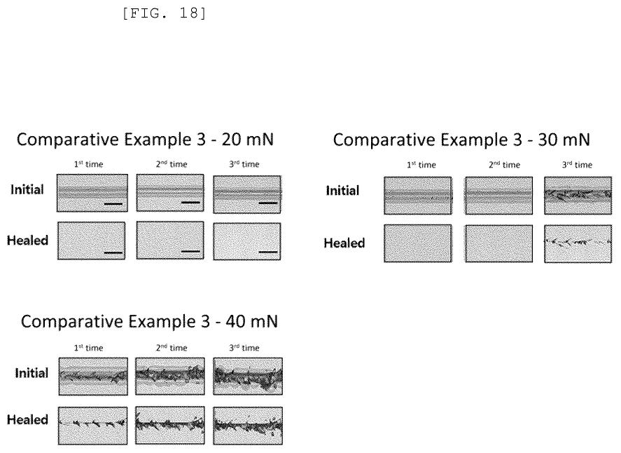

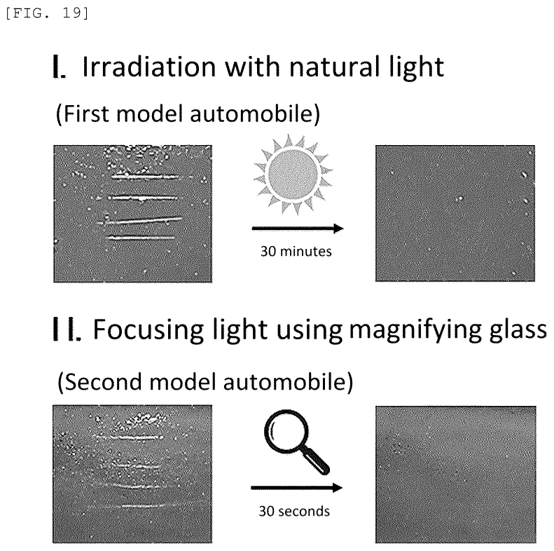

As a result of the self-healing repetitive test, in the first repetition, both the scratch depth and the rupture degree of the coating were increased as the load applied identically to the self-healing test was increased, and when the scratched site was irradiated with 1 W NIR laser for 1 minute, it was confirmed that the self-healing efficiency of Example 2 was higher than that of Comparative Example 3. Referring to FIGS. 17 and 18, even in the experiment with a higher load (40 mN) applied, the coating of Example 2 showed higher self-healing efficiency than the coating of Comparative Example 3.

1. A topical self-healing transparent coating composition capable of forming a polymer network, comprising:
a polyacryl-based resin including a hydroxyl group at the end of a side chain;
a multi-functional alcohol including two or more hindered urea structures in the molecule and a hydroxyl group at both ends of the molecule;
a crosslinking agent including hydroxyl group or isocyanate group; and
a photothermal dye.

2. The topical self-healing transparent coating composition of claim 1, wherein the hydroxyl group of the multi-functional alcohol is included at 10 to 40 mol % of the total hydroxyl groups of the coating composition.

3. The topical self-healing transparent coating composition of claim 1, wherein the isocyanate group of the crosslinking agent is included at a mole ratio of 0.8 to 1.2 to the total hydroxyl groups of the coating composition.

4. The topical self-healing transparent coating composition of claim 1, wherein the hindered urea structure includes a structure of the following Chemical Formula 1 or 2: 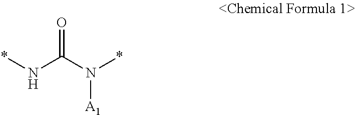
wherein A₁ is a C4 to C7 branched chain alkyl group, 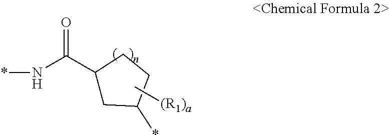
wherein a is 1 to 4, n is 1 to 3, and R₁ is a C1 to C3 straight chain alkyl group.

5. The topical self-healing transparent coating composition of claim 1, wherein the polyacryl-based resin includes a chemical structure represented by the following Chemical Formula 3: 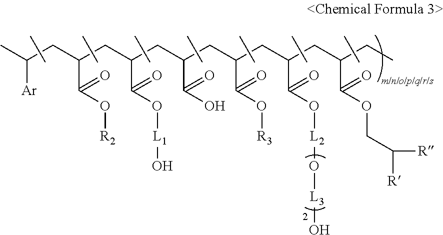
wherein
Ar is aryl, R₂ and R₃ are independently of each other C1 to C4 straight chain or branched chain alkyl, L₁ to L₃ are independently of one another C1 to C4 straight chain or branched chain alkylene, R′ and R″ are independently of each other C1 to C4 straight chain or branched chain alkyl, m is 0 to 1,000, n is 1 to 1,000, o is an integer of 0 to 100, p and s are integers of 0 to 100, and o and r are not 0 at the same time.

6. The topical self-healing transparent coating composition of claim 1, wherein the polyacryl-based resin includes a chemical structure represented by the following Chemical Formula 4: 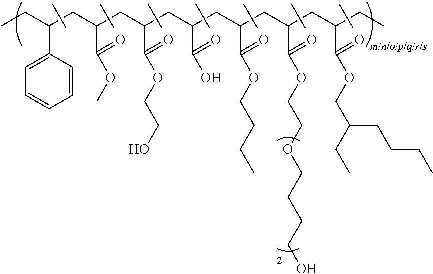
wherein
m is 0 to 1,000, n is 1 to 1,000, o is an integer of 0 to 100, p is an integer of 0 to 100, q and s are integers of 0 to 100, and o and r are not 0 at the same time.

7. The topical self-healing transparent coating composition of claim 1, wherein the multi-functional alcohol is synthesized by reacting a precursor including the hindered urea structure formed by reacting a hindered diamine and a multi-functional and a chained or branched diol.

8. The topical self-healing transparent coating composition of claim 7, wherein the hindered diamine includes N,N′-di-tert-butylethylenediamine or bis(2,2,6,6-tetramethyl-4-piperidyl) sebacate.

9. The topical self-healing transparent coating composition of claim 7, wherein the multi-functional isocyanate includes isophorone diisocyanate (IPDI).

10. (canceled)

11. The topical self-healing transparent coating composition of claim 7, wherein the precursor including the hindered urea structure includes one selected from structures of the following Chemical Formulae 5A and 5B: 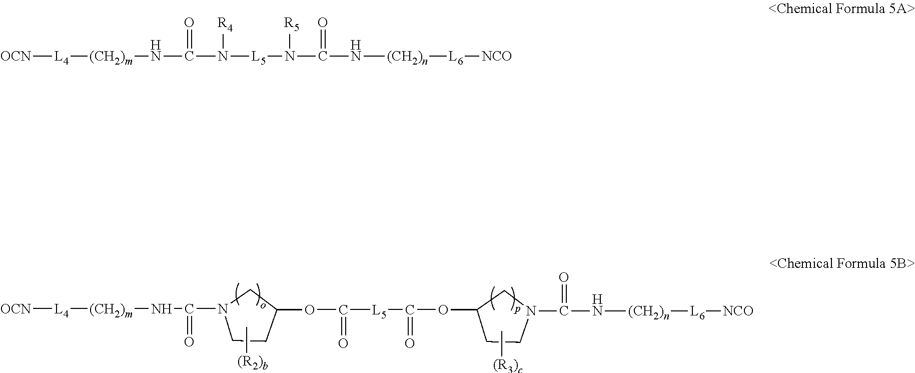
wherein
m and n are 1 to 5, o and p are 1 to 3, b and c are 1 to 5, L₅ is C1 to C10 alkylene, L₄ and L₆ are any one selected from the group consisting of C1 to C10 alkylene and cycloalkylene, the cycloalkylene of L₄ and L₆ may be further substituted by C1 to C10 alkyl, R₂ and R₃ are an alkyl group, and R₄ and R₅ are C4 to C7 branched chain alkyl.

12. The topical self-healing transparent coating composition of claim 7, wherein the precursor including the hindered urea structure includes one selected from structure of the following Chemical Formulae 6A to 6D:

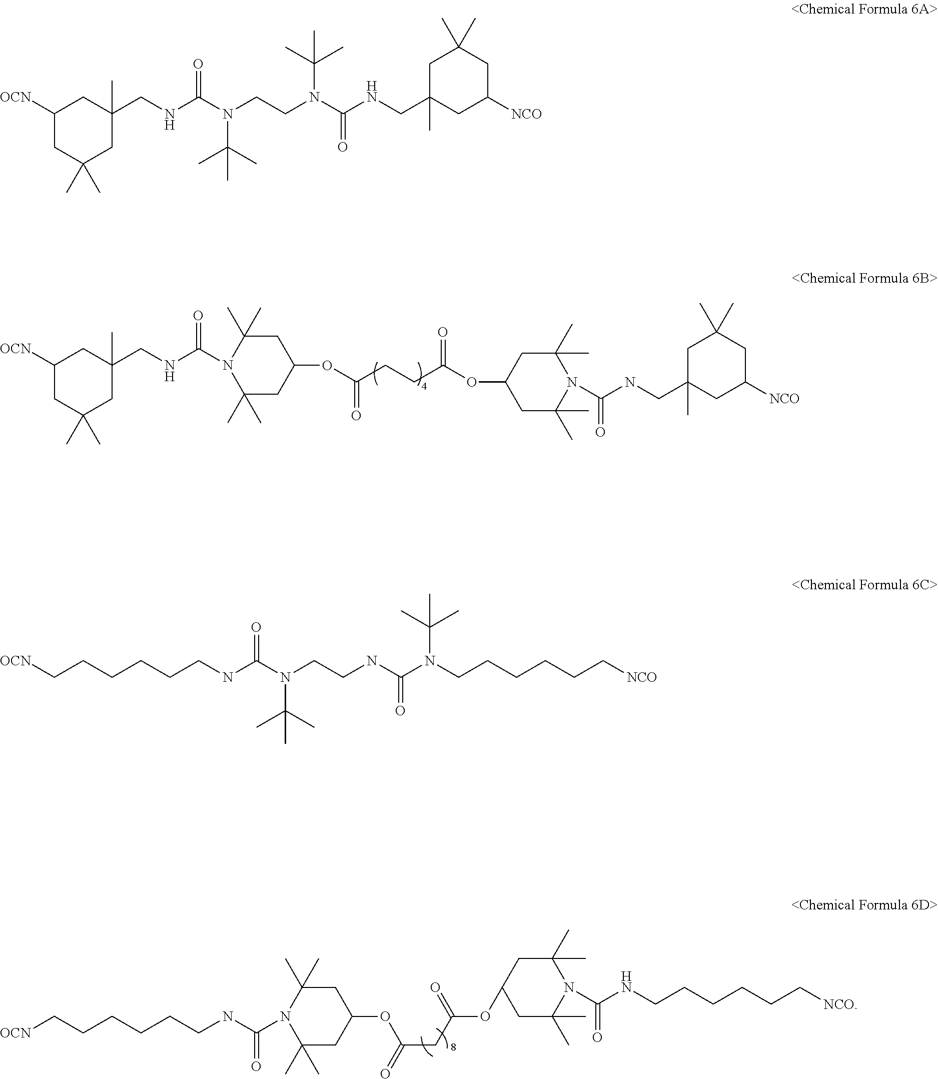

13. The topical self-healing transparent coating composition of claim 1, wherein the multi-functional alcohol includes one selected from structure of the following Chemical Formulae 7A and 7B: 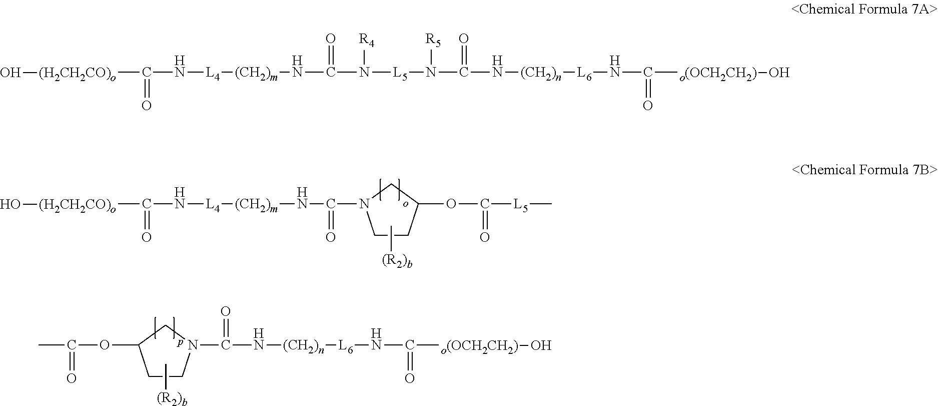
wherein
b, c, m, and n are 1 to 5, o is 1 to 4, p and q are 1 to 3, L₅ is C1 to C10 alkylene, L₄ and L₆ are any one selected from the group consisting of C1 to C10 alkylene and cycloalkylene, the cycloalkylene of L₄ and L₆ may be further substituted by C1 to C10 alkyl, R₂ and R₃ are an alkyl group, and R₄ and R₅ are C4 to C7 branched chain alkyl.

14. The topical self-healing transparent coating composition of claim 1, wherein the multi-functional alcohol includes one selected from the following Chemical Formulae 8A to 8D:

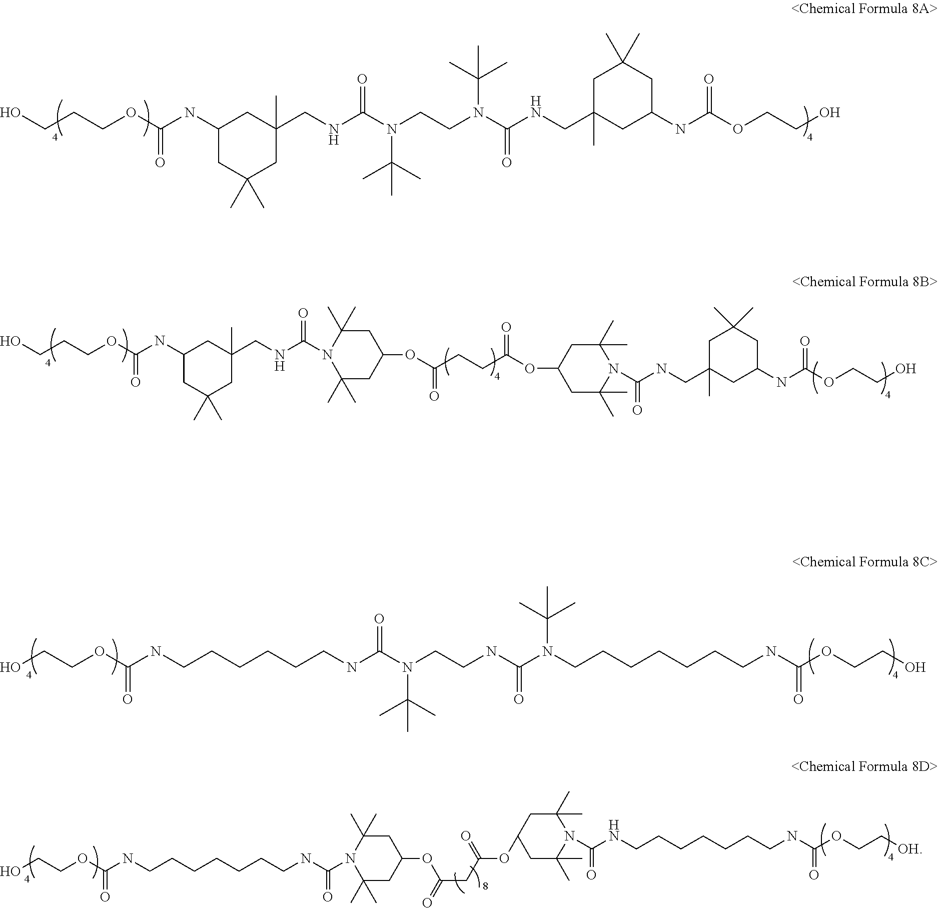

15. The topical self-healing transparent coating composition of claim 1, wherein the photothermal dye includes a chemical structure represented by the following Chemical Formula 9: 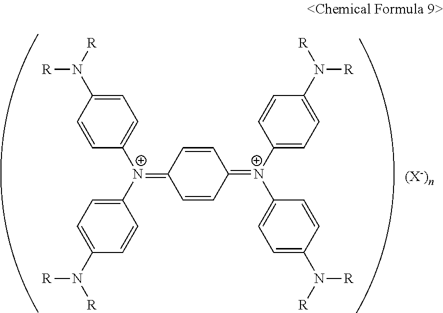
wherein
R is the same as or different from each other and one selected from the group consisting of a hydrogen atom, an alkyl group, an aryl group, an alkoxy group, a hydroxyl group, a phenyl group, or a halogenated alkyl group, X is an anion, and n is 1 or 2.

16. The topical self-healing transparent coating composition of claim 15, wherein the anion includes bis(oxalato)borate.

17. The topical self-healing transparent coating composition of claim 1, wherein the crosslinking agent including hydroxyl group or isocyanate group includes a chemical structure represented by the following Chemical Formula 10: 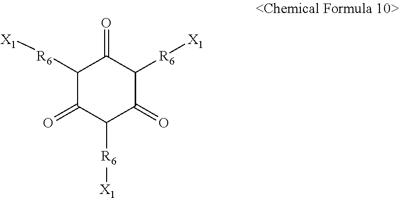
wherein R₆ is independently of each other a C1 to C6 alkyl group, and X₁ is an isocyanate group or hydroxyl group.

18. The topical self-healing transparent coating composition of claim 1, wherein the multi-functional alcohol is included at 5 to 50 parts by weight with respect to 100 parts by weight of the polyacryl-based resin.

19. The topical self-healing transparent coating composition of claim 1, wherein the crosslinking agent including hydroxyl group or isocyanate group is included at 25 to 55 parts by weight with respect to 100 parts by weight of the polyacryl-based resin.

20. The topical self-healing transparent coating composition of claim 1, wherein the photothermal dye is included at 0.01 to 0.50 wt %.

21. A clearcoat having a topical self-healing function formed by a crosslinking reaction of the topical self-healing transparent coating composition of claim 1.

22-26. (canceled)
